(19) United States
(12) Patent Application Publication
(10) Pub. No.: US 2012/0293506 A1
(43) Pub. Date: Nov. 22, 2012

(54) Avatar-Based Virtual Collaborative Assistance

(75) Inventors: Raffaele Vertucci, Napoli (IT); Enrico Boccola, Napoli (IT)

(73) Assignee: Selex Sistemi Integrati S.p.A., Roma (IT)

(21) Appl. No.: 13/508,748

(22) PCT Filed: Nov. 10, 2009
(86) PCT No.: PCT/IT2009/000501

§ 371 Date: Aug. 3, 2012

(51) Int. Cl. G06T 15/00; G09G 5/00

(52) U.S. Cl. 345/419; 345/156; 345/633

(57) ABSTRACT

A collaborative supportive system based upon avatar, comprising movement-tracking sensors, configured for tracking the movements of a user and of one or more parts of his body; a head-mounted display; and processors, configured for co-operating with the movement-tracking sensors and with the head-mounted display to cause the head-mounted display to display an avatar capable of moving around in an environment corresponding to the field of vision of the user and relating with the environment itself and with the user according to the assistance to be provided to the user.

### TECHNICAL FIELD OF THE INVENTION

The present invention relates in general to avatar-based virtual collaborative assistance, and in greater detail to creation of a working, training, and assistance environment by means of techniques of augmented reality.

### BACKGROUND ART

Systems of a known type, for example designed to provide collaborative working environments (CWEs), are advantageously used for remote assistance to an operator in the execution of a plurality of logistic activities (such as, for example, maintenance of equipment or execution of specific operations). Said approach proves particularly advantageous in the case where the operator is in an area that is difficult to access, for example in a place with high environmental risk. In this case, the transport of a specialized technician on the site of the operations, in addition to being costly and inconvenient, could jeopardize the very life of the technician and of the transport personnel.

The operations of remote assistance are based upon the use of audio and/or video communications from and to a remote technical-assistance centre in such a way that the operator in field can be supported remotely by a specialized technician during execution of specific operations, for example, maintenance. In many cases, the in-field operator has available one or more video cameras via which pictures or films can be taken of the site or of the equipment on which to carry out the intervention to transmit them to the specialized technician, who in this way can assist the operator more effectively.

This type of approach presents, however, a series of intrinsic limits. In the first place, the instructions furnished by the specialized technician are limited to voice instructions that must be interpreted and executed by the in-field operator. In addition, it is necessary to have available a data-transmission network with a sufficiently wide band, such as to guarantee for the specialized technician a clear and high-resolution vision of the films or pictures taken. It is moreover problematical to furnish the specialized technician simultaneously with an overall view and a detailed view of the site and/or of the equipment on which it is necessary to intervene. The latter limit can in part be overcome using stereoscopic techniques, which, however, call for an even wider transmission band. Said solution is hence difficult to implement in places with limited connectivity.

A further possible solution to said problems envisages the creation of virtual-reality environments that ensure a faithful reproduction the site and equipment on which the operator might have to intervene. The virtual reconstruction of the site and of the equipment on which it is necessary to intervene reside both on a processor used by the specialized technician and on a processor used by the in-field operator. The specialized technician can hence intervene directly within the virtual environment by showing to the operator present on the site in which intervention has been requested the operations to be performed. This solution, however, requires a considerable computational effort for creating a virtual environment that will represent the actual site and equipment faithfully.

### OBJECT AND SUMMARY OF THE INVENTION

The present invention regards a system and the corresponding method for providing a collaborative assistance and/or work environment having as preferred range of application execution of logistic activities (installation, maintenance, execution of operations, training, etc.) at nomadic operating sites, using augmented-reality techniques and applications.

In the current technical language, the term “augmented reality” is frequently used to indicate techniques and applications in which the visual perception of the physical space is augmented by superimposing on a real picture (of a generic scenario) one or more virtual elements of reality. In this way, a composite scene is generated in which the perception of the reality is virtually enriched (i.e., augmented) by means of additional virtual elements, typically generated by a processor. The operator that uses the augmented reality perceives a composite final scenario, constituted by the real scenario enriched with non-real or virtual elements. The real scenario can be captured by means of photographic cameras or video cameras, whilst the virtual elements can be generated by computer using appropriate assisted-graphic programs or, alternatively, are also acquired with photographic cameras or video cameras. By integrating the virtual elements with the real scenario a final scenario is obtained in which the virtual elements integrate in a natural way into the real scenario, enabling the operator to move freely in the final scenario and possibly interact therewith.

The architecture of the augmented-reality system basically comprises a hardware platform and a software platform, which interact with one another and are configured in such a way that an operator, equipped with appropriate VR goggles or helmet for viewing the augmented reality, will visually perceive the presence of an avatar, which, as is known, is nothing other than a two-dimensional or three-dimensional graphic representation generated by a computer that may vary in theme and size and usually assumes human features, animal features, or imaginary features, and graphically embodies a given function of the system. Preferably, the avatar has a human physiognomy and is capable of interacting (through words and/or gestures) with the operator to guide him, control him, and assist him in performing an action correctly in the real and/or virtual working environment.

The avatar can have different functions according to the applicational context of use of the augmented-reality system (work, amusement, training, etc.). The movements, gestures, and speech of the avatar, as likewise its graphic representation, are managed and governed by an appropriate software platform.

Furthermore, the augmented-reality contents displayed via the VR goggles or helmet can comprise, in addition to the avatar, further augmented-reality elements, displayed superimposed on the real surrounding environment or on an environment at least partially generated by means of virtual-reality techniques.

Advantageously, the avatar can be displayed in such a way that its movements appear natural within the real or virtual representation environment and the avatar can occupy a space of its own within the environment. This means that the avatar can exit from the field of vision of the operator if the latter turns his gaze, for example by 180 degrees. Furthermore, it is convenient for the avatar to be able to relate properly with the surrounding environment and with the elements or the equipment present therein in order to be able, for example, to indicate precisely (by gestures of its own) portions or details of said elements or equipment; at the same time, there should be envisaged control mechanisms for recognizing and possibly correcting the actions undertaken by the operator.

For this purpose, and to be able to control the actions of the avatar appropriately, the capacity of the augmented-reality system for detecting the movements of the body of the operator and the position of the elements present in the surrounding environment assumes particular importance.

To obtain the effect described devices for tracking the movements in three dimensions of various types may be used. There exist on the market different types of three-dimensional tracking devices suitable for this purpose.

The fields of application of the present invention may be multiple. For example, the system according to the invention enables training sessions to be carried out in loco or at a distance, and is in general valuable for all those training requirements in which interaction with an instructor proves to be advantageous for the learning purposes; it enables provision of support to the logistics (installation, maintenance, etc.) of any type of equipment or apparatus; it provides a valid support to surgeons in the operating theatre, in order to instruct them on the use of the equipment or to assist them during surgery; or again, it may be used in closed environments during shows, fairs, exhibitions, or in open environments, for example in archaeological areas, for guiding and instructing the visitors and interacting with them during the visit.

### BRIEF DESCRIPTION OF THE DRAWINGS

For a better understanding of the present invention there is now described a preferred embodiment thereof, purely by way of a non-limiting example, with reference to the attached drawings, in which:

FIG. 1 shows a hardware architecture of an augmented-reality system according to one embodiment of the present invention;

FIG. 2 shows, by means of a block diagram, steps of a method of display of an avatar and execution of procedures in augmented reality according to one embodiment of the present invention;

FIG. 3 shows, in schematic form, a software architecture of an augmented-reality system according to one embodiment of the present invention;

FIGS. 4-7 show, by means of block diagrams, respective methods of use of the augmented-reality system.

### DETAILED DESCRIPTION OF PREFERRED EMBODIMENTS OF THE INVENTION

The ensuing discussion is presented to enable a person skilled in the art to implement and use the invention. Various modifications to the embodiments will be evident to persons skilled in the art, without thereby departing from the scope of the present invention as claimed. Consequently, the present invention is not understood as being limited to the embodiments illustrated, but it must be granted the widest scope in accordance with the principles and characteristics illustrated in the present description and defined in the annexed claims.

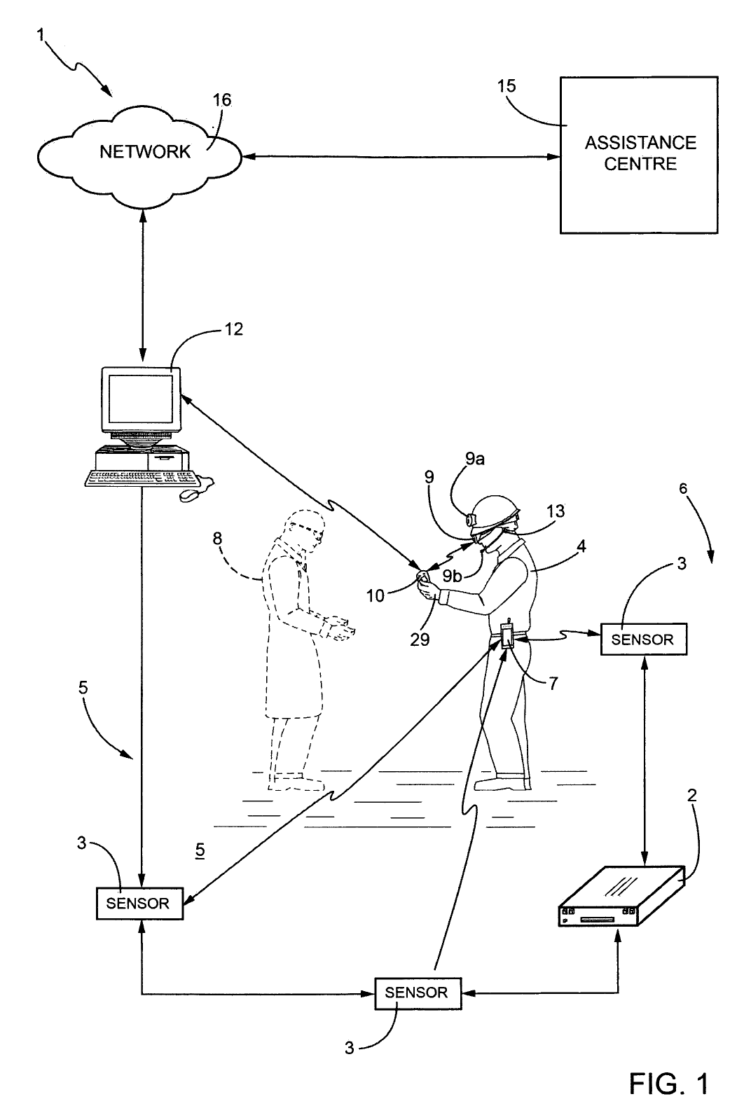

FIG. 1 shows a possible hardware architecture of a collaborative supportive system 1, which uses augmented-reality techniques, according to a preferred embodiment of the present invention.

In detail, the collaborative supportive system 1 comprises a movement-tracking apparatus 6, which in turn comprises at least one movement-tracking unit 2 and one or more environmental sensors 3, connected with the movement-tracking unit 2 or integrated in the movement-tracking unit 2 itself. In use, the movement-tracking apparatus 6 is configured for detecting the position and movements of an operator 4 (or of parts of the body of the operator 4) within an environment 5, whether closed or open. For this purpose, the collaborative supportive system 1 can moreover comprise one or more movement sensors 7 that can be worn by the operator 4 (by way of example, FIG. 1 shows a single movement sensor 7 worn by the operator 4), which are designed to co-operate with the environmental sensors 3. The environmental sensors 3 detect the position and/or the movements of the movement sensors 7 and, in the form of appropriately encoded data, send them to the movement-tracking unit 2. The movement-tracking unit 2 gathers the data received from the environmental sensors 3 and processes them in order to detect the position and/or the movements of the movement sensors 7 in the environment 5 and, consequently, of the operator 4. Said data can moreover be sent to a local server 12 together with images acquired through one or more environmental high-definition video cameras 19 distributed in the environment 5.

The collaborative supportive system 1 further comprises a head-mounted display (HMD) 9, that can be worn by a user, in the form of VR (virtual-reality) helmet or VR goggles, preferably including a video camera 9a of a monoscopic or stereoscopic type, for filming the environment 5 from the point of view of the operator 4, and a microphone 9b, for enabling the operator to impart voice commands. The collaborative supportive system 1 further comprises a sound-reproduction device 13, for example earphones integrated in the head-mounted display 9 or loudspeakers arranged in the environment 5 (the latter are not shown in FIG. 1).

In addition, the HMD 9 is capable of supporting augmented-reality applications. In particular, the HMD 9 is preferably of an optical see-through type for enabling the operator 4 to observe the environment 5 without filters that might vary the appearance thereof. Alternatively, the HMD 9 can be of a see-through-based type interfaced with the video camera 9a (in this case preferably stereoscopic) for proposing in real time to the operator 4 films of the environment 5, preferably corresponding to the field of vision of the user. In this case, the avatar 8 is displayed superimposed on the films of the environment 5 taken by the video camera 9a.

The collaborative supportive system 1 further comprises a computer device 10 of a portable type, for example a notebook, a palm-top, a PDA, etc., provided with appropriate processing and storage units (not shown) designed to store and generate augmented-reality contents that can be displayed via the HMD 9. For this purpose, the HMD 9 and the portable computer device 10 communicate with one another via a wireless connection or via cable indifferently.

The portable computer device 10 can moreover communicate with the local server 12, for example via a wireless connection, to transmit and/or receive further augmented-reality contents to be displayed via the HMD 9. Furthermore, the portable computer device 10 receives from the local server 12 the data regarding the position and/or the movements of the operator 4 processed by the movement-tracking unit 2 and possibly further processed by the local server 12. In this way, the augmented-reality contents generated by the portable computer device 10 and displayed via the HMD 9 can vary according to the position assumed by the operator 4, his movements, his interactions and actions.

The interaction of the avatar 8 with the operator 4 and the constant control of the actions carried out by the operator 4 are implemented through the movement-tracking unit 2, the environmental sensors 3, the movement sensors 7, and the microphone 9b, which operate in a synergistic way. In particular, whereas the movement-tracking unit 2, the movement sensors 7, and the environmental sensors 3 are configured for detecting the position and the displacements of the operator 4 and of the objects present in the environment 5, the microphone 9b is advantageously connected (for example, via a wireless connection, of a known type) to the portable computer device 10, and is configured for sending to the portable computer device 10 audio signals correlated to possible voice expressions of the operator 4. The portable computer device 10 is in turn configured for receiving said audio signals and interpreting, on the basis thereof, the semantics and/or particular voice tones of the voice expressions uttered by the operator 4 (for example, via voice-recognition software of a known type).

Particular voice tones, facial expressions, and/or postures or, in general, any expression of the body language of the operator 4 can be used for interpreting the degree of effectiveness of the interaction between the avatar 8 and the operator 4. For example, a prolonged shaking of the head by the operator 4 can be interpreted as a signal of doubtfulness or dissent of the operator 4; a prolonged shaking of the head in a vertical direction can be interpreted as a sign of assent of the operator 4; or again, frowning on the part of the operator 4 can be interpreted as a signal of doubt of the operator 4. Other signs of the body language can be used for interpreting further the degree of effectiveness of the interaction between the avatar 8 and the operator 4.

The local server 12 can moreover set up a communication with a technical-assistance centre 15, presided over by a (human) assistant and located at a distance from the environment 5 in which the operator 4 is found. In this case, the local server 12 is connected to the technical-assistance centre 15 through a communications network 16 (for example, a telematic network, a telephone network, or any voice/data-transmission network). The augmented-reality contents displayed via the HMD 9 comprise, in particular, the avatar 8, represented in FIG. 1 with a dashed line, in so far as it is visible only by the operator 4 equipped with appropriate HMD 9. Preferably, the avatar 8 is an image perceived by the operator 4 as three-dimensional and represents a human figure integrated in the real environment 5 capable of acting in relation with the environment 5, possibly modifying it virtually, and with the operator 4 himself. The modifications made by the avatar 8 to the environment 5 are also represented by augmented-reality images, visible by the operator 4 equipped with HMD 9.

A suitable software architecture (described in greater detail in what follows) enables graphic definition of the avatar 8 and its possibilities of interacting and relating with the environment 5. Said software architecture can advantageously comprise a plurality of software modules, each with a specific function, resident in respective memories (not shown) of the movement-tracking unit 2 and/or of the local server 12 and/or of the computer device 10. The software modules are designed to process appropriately the data coming from the environmental sensors 3 in order to define with a certain precision (depending, for example, upon the type of environmental sensors 3 and movement sensors 7 used) the movements and operations that the operator 4 performs on the objects present in the environment 5. It is thus possible to control the computer device 10 in such a way as to manage the display of the avatar 8 according to the movements of the operator 4 or of parts of his body in the environment 5. Advantageously, the avatar 8 can be displayed in such a way that its movements appear natural within the environment 5. For example, the avatar 8 can relate with the environment 5 both in a way independent of the movements of the operator 4 and in a way dependent thereon. For example, the avatar 8 can exit from the field of vision of the operator 4 if the latter turns his gaze by, for example, 180 degrees, or else the avatar 8 can move about in the environment 5 so as to interact with the operator 4. It is hence evident that the particular procedure performed by the avatar 8 varies according to the actions that the operator 4 performs. Said actions are, as has been said, defined on the basis of the attitudes and/or of the tones of voice that the operator 4 himself supplies implicitly and/or explicitly to the processing unit 10 through the movement-tracking unit 6, the movement sensors 7, the environmental sensors 3, the environmental video cameras 19, or other types of sensors still.

The avatar 8 must moreover be able to relate properly with the environment 5 and with the elements or the equipment present in the environment 5 so as to be able to instruct and/or assist the operator 4 in the proper use of said elements or equipment, using gestures and/or words of his own.

For this purpose, of particular importance is the capacity of the collaborative supportive system 1 to detect the position and the movements of the operator 4 (or of one or more of the parts of his body) and of the elements present in the environment 5 to be able to govern the actions of the avatar 8 accordingly. The avatar 8 should preferably position itself in the environment 5 in a correct way, i.e., without superimposing itself on elements or objects present in the environment 5 in order to set up a realistic relationship with the operator 4 (for this purpose, the avatar 8 can be configured in such a way that, when it speaks, it makes gestures and follows the operator 4 with its gaze).

To obtain the technical effect described it is possible to use movement-tracking equipment 6 in two or more dimensions. In particular, the recent development and diffusion of 3D-modelling application packages has led to the creation of interactive graphic interfaces for navigation and rotation in three dimensions. Said application packages, in fact, define the position of a generic object (and of the elements that make it up) in space, on the basis of three spatial co-ordinates (x_{O}, y_{O}, z_{O}) and of the orientation with respect to a reference system indicated by three angles (roll r_{OX}, yaw r_{OY}, and pitch r_{OZ}) of rotation about each of the three spatial co-ordinates. The capability of controlling in an independent way at least six variables is a particularly useful characteristic in 3D-modelling application packages. Said application packages are moreover configured for faithful modelling the reality, also as regards the modes with which a human being interacts with the objects of everyday use. From a technological standpoint, movement-tracking equipment 6 associated to appropriate software application packages enables conversion of a physical phenomenon, such as a force or a velocity, into data that can be processed and represented on a computer.

Existing on the market are different kinds of movement-tracking equipment 6 of this type. Generally, movement-tracking equipment 6 is classified on the basis of the technology that it uses for capturing and measuring the physical phenomena that occur in the environment 5 where it is operating.

For example, movement-tracking equipment 6 of a mechanical type may be used, which comprises a mechanical skeleton constituted by a plurality of rods connected to one another by pins and comprising a plurality of movement sensors 7, for example, electrical and/or optical sensors. Said mechanical skeleton is worn by the operator 4 and detects the movements made by the operator 4 himself (or of one or more parts of his body), enabling tracing the position thereof in space.

Alternatively, it is possible to use movement-tracking equipment 6 of an electromagnetic type. Said equipment comprises: one or more movement-tracking units 2; a plurality of environmental sensors 3, for example electromagnetic-signal transmitters, connected to the movement-tracking unit 2 and arranged within the environment 5; and one or more movement sensors 7, which act as receivers of the electromagnetic signal transmitted, suitably arranged on the body of the operator 4, for example on his mobile limbs. The movements of the operator 4 correspond to a respective variation of the electromagnetic signal detected by the movement sensors 7, which can hence be processed in order to evaluate the movements of the operator 4 in the environment 5. Movement-tracking equipment 6 of this type is, however, very sensitive to electromagnetic interference, for example caused by electronic apparatuses, which may impair precision of the measurement.

A further type of movement-tracking equipment 6 comprises environmental sensors 3 of an optical type. In this case, the movement sensors 7 substantially comprise a light source (for example LASER or LED), which emits a light signal, for example of an infrared type. The environmental sensors 3 operate in this case as optical receivers, designed to receive the light signals emitted by the movement sensors 7. The variation in space of the light signals is then set in relationship with respective movements of the operator 4. Devices of this type are advantageous in so far as they enable coverage of a very wide working environment 5. However, they are subject to possible interruptions of the optical path of the light signals emitted by the movement sensors 7. Any interruption of the optical path should be appropriately prevented to obtain optimal performance. Alternatively, it is possible to guarantee the optical path by providing an adequate number of environmental sensors 3, such as to guarantee a complete coverage of the environment 5.

Other types of movement-tracking equipment 6 that can be used comprise environmental sensors 3 of an acoustic type. Also in this case, as has been described previously, it is expedient to arrange one or more environmental sensors 3 preferably within the environment 5 and one or more movement sensors 7 on the body of the operator 4. In this case, however, the movement sensors 7 operate as transmitters of sound waves, and the environmental sensors 3 operate as receivers of the transmitted sound waves. The movements of the operator 4 are detected by measuring the variations in time taken by the sound waves to traverse the space between the movement sensors and the environmental sensors 3. This type of devices, albeit presenting the advantage of being economically advantageous and readily available, do not however guarantee a high precision if the working environment 5 is a closed one on account of the possible reflections of the sound waves against the walls of the environment 5.

Further movement-tracking equipment 6 that can be used envisages use of movement sensors 7 comprising gyroscopes for measuring the variations of rotation about one or more reference axes. The signal generated by the gyroscopes can be transmitted to the movement-tracking unit 2 through a wireless connection so that it can be appropriately processed. In this case, it is not necessary to envisage the use of environmental sensors 3.

Furthermore, above all in the case of non-predefined procedures, the technician in the technical-assistance centre 15 can assist the operator 4, governing the avatar 8 in real time and observing the environment 5, the operator 4, and the equipment on which it is necessary to intervene. In this case, it is expedient to arrange a plurality of controllable video cameras (for example, mobile ones or ones with the possibility of variation of the focus), configured for transmitting high-resolution images with different frames both of the environment 5 and of the equipment on which the operator 4 is operating. Said video cameras are preferably arranged in such a way as to be able to guarantee at all times a good visual coverage of the entire the environment 5 and of the equipment in which the intervention is requested. It is consequently evident that said video cameras can be arranged appropriately only when necessary and with a different arrangement according to the working environment 5.

Finally, as an alternative to the movement-tracking equipment described or in addition to one or more thereof, it is possible to furnish the operator 4 with wired gloves 29 (also referred to as Cybergloves®), of a known type, provided with sensors, the purpose of which is to carry out a real-time detection of bending or adduction of the fingers of one hand (or both hands) of the user, which are at the basis of any gesture. Wired gloves 29 of a known type are capable of detecting movements of bending/adduction and interpret them as gestural and/or behavioural commands that can be supplied, for example via a wireless connection, to the movement-tracking unit 2, for instance for selecting or activating functions of a software application, without resorting to a mouse or a keyboard.

In the case where the working environment 5 is an open place and the distances that the operator 4 must or can traverse are particularly long, it is evident that some of the movement-tracking equipment 6 previously described may prove cumbersome or difficult to install. In this case, it may be useful to set alongside any of the movement-tracking apparatuses 6, or as a replacement thereof, a GPS (Global Positioning System) receiver co-operating with an appropriate GPS navigation software. The GPS navigation software, for example resident in a memory of the computer device 10, is interfaced, via the computer device 10, with the movement-tracking unit 2 and/or with the local server 12, and furnishes the position of the operator 4 and his displacements. The collaborative supportive system 1 is thus aware, within the limits of sensitivity of the GPS system, of the movements and displacements of the operator 4 in an open environment 5 and can consequently manage display of the avatar 8 in such a way that, for example, it also displaces together with the operator 4.

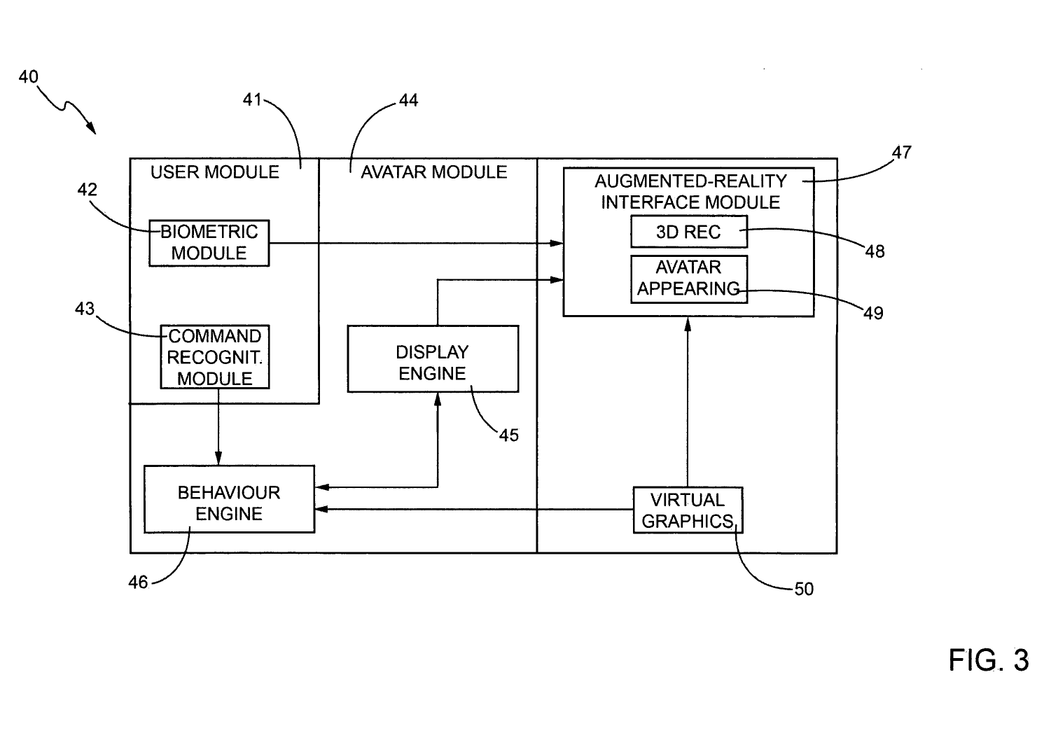

Irrespective by the type of movement-tracking apparatus 6 used, it is expedient to envisage an appropriate software platform (shown and described hereinafter with reference to FIG. 3 and identified by the number 40), for example of a modular type, comprising one or more modules and resident, as has been said, in respective memories of the movement-tracking unit 2 and/or of the local server 12 and/or of the portable computer device 10.

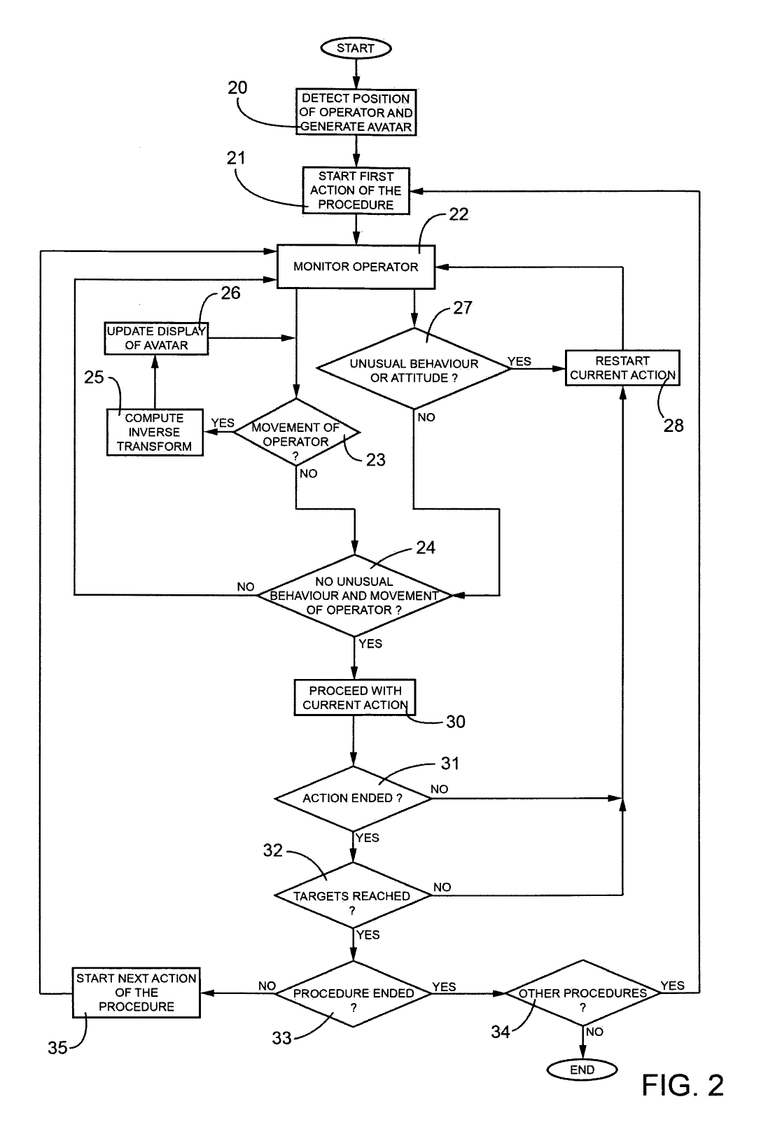

The steps implemented by the software platform 30 are shown in FIG. 2.

In the first place (step 20 of FIG. 2), the operator 4 sets underway a virtual collaborative supportive procedure, for displaying the avatar 8. The position and orientation of the operator 4 (provided, according to one embodiment of the present invention, with movement sensors 7 and HMD 9) are detected with reference to the surrounding environment 5 (for example, with the aid of the environmental sensors 3 and/or video cameras and/or, as better described in what follows, by locating virtually the operator 4 within a digital map of the environment 5), and an avatar 8 is generated, through the HMD 9 and visible to the operator 4, in the working environment 5. As described previously, the position and orientation of the operator 4 are preferably detected by identifying six degrees of freedom (the three spatial co-ordinates x_{O}, y_{O}, z_{O} and the angles r_{OX}, r_{OY}, r_{OZ} of roll, yaw, and pitch).

Next (step 21), the working (or assistance, or training) procedure is set underway on request of the operator 4. During this step, in addition to starting a specific procedure, it is also possible to set threshold values of the spatial co-ordinates x_{Oi}, y_{Oi}, z_{Oi} and of the angles r_{OXi}, r_{OYi}, r_{OTi} (stored in the local server 12) used subsequently during step 23.

The working procedure set underway in step 21 can be advantageously divided into one or more (elementary or complex) subroutines that return, at the end thereof, a respective result that can be measured, analysed, and compared with reference results stored in the local server 12. The result of each subroutine can be evaluated visually by an assistant present in the technical-assistance centre 15 (who visually verifies at a distance, for example via a video camera, the outcome of the operations executed by the operator 4), or else in a totally automated form through diagnostic tools of the instrumentation on which the operator 4 is operating (diagnostic tools can, for example, detect the presence or disappearance of error signals coming from electrical circuits or the like).

Then (step 22), whilst the operator 4 carries out the operations envisaged by the working procedure (assisted in this by the avatar 8), the movement-tracking apparatus 6 and/or the movement sensors 7 and/or the microphone 9b and/or the wired gloves 29 and/or the environmental video cameras 19 carry out a constant and continuous monitoring of the spatial co-ordinates x_{O}, y_{O}, z_{O} and of the angles of roll, yaw, and pitch r_{OX}, r_{OY}, r_{OZ} associated to the current position of the operator 4, but also of further spatial co-ordinates x_{P}, y_{P}, z_{P} and angles of roll, yaw, and pitch r_{PX}, r_{PY}, r_{PZ} associated to the position of parts of the body of the operator 4, as well as of voice signals and messages issued by the operator 4. Said data (spatial co-ordinates, angles of roll, yaw, and pitch, and voice signals) are stored by the movement-tracking unit 2.

Next, the data stored are processed to carry out control of the position and behaviour of the operator 4.

In step 23, the spatial co-ordinates x_{Oi}, y_{Oi}, z_{Oi} and the angles of roll, yaw, and pitch r_{OXi}, r_{OYi}, r_{OTi} associated to the current position of the operator 4 at the i-th instant are compared with respective spatial co-ordinates x_{O(i-1)}, y_{Oi-1}, z_{Oi-1} and angles of roll, yaw, and pitch r_{OX(i-1)}, r_{OY(i-1)}, r_{Oz(i-1)} associated to the current position of the operator 4 at the (i−1)-th instant preceding to the i-th instant. If the operation of comparison of step 23 yields a negative outcome (i.e., the three spatial co-ordinates x_{O}, y_{O}, z_{O} and the angles r_{OX}, r_{OY}, r_{OZ} have substantially remained unvaried with respect to the preceding ones), then (output NO from step 23) control passes to step 24. Instead, if the operation of comparison yields a positive outcome (i.e., the three spatial co-ordinates x_{Oi}, y_{Oi}, z_{Oi} and the angles r_{OXi}, r_{OYi}, r_{OTi} have varied), then (output YES from step 23) a movement of the operator 4 has occurred.

It is clear that the three spatial co-ordinates x_{Oi}, y_{Oi}, z_{Oi} and the angles r_{OXi}, r_{OYi}, r_{OTi} are considered as having varied from the i-th instant to the (i−1)-th instant if they change beyond respective threshold values (for example, set during step 21 or defined previously). Said threshold values are defined and dictated by the specific action of the collaborative supportive procedure for which the avatar 8 is required to intervene and are preferably of a higher value than the minimum tolerances of the movement sensors 7 or of the environmental sensors 3 used.

The use of threshold values during execution of step 23 makes it possible not to interrupt the current action if, to perform the action itself, the operator 4 has to carry out movements, possibly even minimal ones, and hence is not perfectly immobile.

Output YES from step 23 issues a command (step 25) for updating of the position of the avatar 8 perceived by the operator 4. Step 25 can advantageously be implemented using appropriate application packages of a software type. For example, by mathematically defining the position of the operator 4 and the position of the avatar 8, it is possible to describe, by means of a mathematical function ƒ, any detected movement of the operator 4. Then, using a mathematical function ƒ⁻¹, which is the inverse of the mathematical function ƒ, to identify the position of the avatar 8, it is possible to counterbalance the displacements of the head of the operator 4 and display the avatar 8 still in one and the same place. Alternatively, using the mathematical function ƒ to define the position of the avatar 8, it is possible to control the avatar in order for it to follow the operator 4 in his displacements. Again, the avatar 8 can be controlled in its movements according to a further mathematical function, different from the mathematical functions ƒ and ƒ⁻¹ and capable of ensuring that the avatar 8 will not set itself between the operator 4 and the object or apparatuses on which intervention is to be carried out.

Then (step 26), the representation of the avatar 8 supplied by the HMD 9 to the operator 4 is updated, and control returns to step 23.

In particular, the avatar 8 can be displayed always in the same position with respect to the environment 5 or as moving freely within the environment 5, and can consequently exit from the view of the operator 4.

Simultaneously with and in parallel to step 23, a step 27 is executed, in which, in addition to analysing the tones and the vocabulary of possible voice messages of the operator 4, the spatial co-ordinates x_{Pi}, y_{Pi}, z_{Pi} and angles of roll, yaw, and pitch r_{Pi}, r_{Pi}, r_{Pi} associated to the current position of parts of the body of the operator 4 at the i-th instant are processed and compared with values of spatial co-ordinates x_{P(i-1)}, y_{P(i-1)}, z_{P(i-1)} and angles of roll, yaw, and pitch r_{P(i-1)}, r_{P(i-1)}, r_{P(i-1)} detected previously at the (i−1)-th instant. This enables identification of possible behaviours, attitudes, postures, vocal messages and/or tones of voice and operations made by the operator 4 that can be symptomatic of a perplexity, a lack of attention, and in general a difficulty to perform the current action by the operator 4.

In addition, to identify precisely the movements of the operator 4 in the environment 5 it is convenient to provide, by means of known virtual-reality techniques, a three-dimensional digital map (for example, implemented through a matrix) of the environment 5 and of the equipment present in the environment 5 before the operator 4 starts to modify the environment 5 itself by means of the work that he is performing. In this way, it is possible to track each movement of the operator 4 within the environment 5 precisely by defining each movement of the operator 4 on the basis of co-ordinates identified in the digital map. Each action or movement of the operator 4 in the environment 5 is hence associated to a corresponding action or movement within the digital map (or matrix). With reference to FIG. 1, the digital map can be generated by the local server 12 or by the movement-tracking unit 2, and stored in a memory within said local server or movement-tracking unit.

If step 27 yields a negative outcome (i.e., the behaviours, attitudes, postures, vocal messages, and/or tones of voice and operations of the operator 4 that have been detected are not symptomatic of perplexity, lack of attention, or difficulty in performing the current action), then (output NO from step 27) control passes to step 24.

Instead, if the operation of comparison of step 27 yields a positive outcome (i.e., the behaviours, attitudes, postures, vocal messages, and/or tones of voice and operations of the operator 4 that have been detected are symptomatic of perplexity, lack of attention, or difficulty in performing the current action), then (output YES from step 27) this means that there is an unusual behaviour and/or attitude on the part of the operator 4 that could jeopardize success of the current action.

Output YES from step 27 brings about (step 28) interruption of the current action and a possible request by the avatar 8 to the operator 4 (for example, by means of vocal and/or gestural commands imparted by the avatar 8 directly to the operator 4) for re-establishing the initial state and conditions of the environment 5, of the instruments, and/or of the equipment on which the operator 4 is carrying out the current action.

Step 28 can be implemented using an appropriate application package of a software type. In particular, it is possible to model, through a mathematical function g, each action carried out by the operator 4 (each action or movement of the operator is in fact known and can be detected and described mathematically through the digital map referred to previously). Consequently, in the case of an improper action, a mathematical function g⁻¹ is used, which is the pseudo-inverse of the mathematical function g, for controlling actions and movements of the avatar 8 (which are corrective with respect to the improper actions and movements performed by the operator 4) and show to the operator 4, through said actions and movements of the avatar 8, which actions to undertake to restore the safety conditions of the environment and to re-establish the last correct operating state in which the instruments and/or the equipment present in the working environment 5 were before the improper action was performed.

Output YES from step 24 is enabled only in the case where the output from steps 23 and 27 is NO for both of the outputs (no unusual behaviour or attitude and no movement of the operator).

Step 24 has the function of synchronizing the independent and parallel controls referred to in steps 23 and 27, set underway following upon step 22, and of ensuring that the current action proceeds (step 30) only when no modifications of behaviour or of visual representation of the avatar 8 are necessary in order to supply indications to the operator 4. Following upon step 30, a check is made (step 31) to verify whether the current action is through, i.e., verify whether the operator 4 has carried out all the operations envisaged and indicated to the operator 4 by the avatar 8 (for example, ones stored in a memory of the local server 12 or of the movement-tracking unit 2 in the form of an orderly list of fundamental steps to be carried out). In particular, if the action has not been completed (output NO from step 31), control returns to step 22. This is repeated until the current action is through, and (output YES from step 31) control passes to step 32.

In step 32, the results obtained at the end of the current action are compared with the pre-set targets (which are, for example, stored in a memory of the local server 12 or of the movement-tracking unit 2 in the form of states of the instrumentation and/or of the equipment present in the working environment 5 and on which the avatar 8 can interact); if said targets have been achieved (output YES from step 32), control passes to step 33; otherwise (output NO from step 32), control returns to step 28.

Step 33, recalled at the end of a current action carried out by the operator 4 under the control of the avatar 8, verifies whether all the actions envisaged by the current procedure for which the avatar 8 is at that moment used are completed. In this case, if all the actions of the procedure are through (output YES from step 33), control passes to step 34; otherwise (output NO from step 33), control passes to step 35, which recalls and sets underway the next action envisaged by the current procedure.

Step 34 has the function of verifying whether the operator 4 requires (for example, via the computer device 10) execution of other procedures or whether the intervention for which the avatar 8 has been used is through. In the first case (output YES from step 34), control returns to step 21 for setting underway the actions of the new procedure; otherwise (output NO from step 34), the program terminates and consequently also the interaction of the avatar 8 with the operator 4 terminates.

In addition to the steps described previously with reference to FIG. 2, further mechanisms for controlling the safety of the operator 4, of the equipment, and of the instrumentation present in the environment 5 are possible for interrupting, stopping, and/or terminating the procedure for which the avatar 8 is currently being used, even if one or more actions of the procedure itself are not terminated.

FIG. 3 shows a block diagram of a software platform 40 that implements steps 20-35 of the flowchart of FIG. 2, according to one embodiment of the present invention

The software platform 40 comprises a plurality of macromodules, each in turn comprising one or more functional modules.

In greater detail, the software platform 40 comprises: a user module 41, comprising a biometric module 42 and a command-recognition module 43; an avatar module 44, comprising a display engine 45 and a behaviour engine 46; an augmented-reality interface module 47, comprising a 3D-recording module 48 and an appearance-of-avatar module 49; and, optionally, a virtual-graphic module 50.

In greater detail, the biometric module 42 of the user module 41 determines the position, orientation, and movement of the operator 4 or of one or more parts of his body and, according to these parameters, updates the position of the avatar 8 perceived by the operator 4 (as described previously).

In particular, the algorithm is based upon processing of the information on the position of the operator 4, in two successive (i−1)-th and i-th instants of time so as to compare them and access whether it is advantageous to make modifications to spatial co-ordinates (x_{A}, y_{A}, z_{A}) of display of the avatar 8 in the environment 5.

For this purpose, the biometric module 42 is connected to the augmented-reality interface module 47 and resides in a purposely provided memory of the movement-tracking unit 2.

The command-recognition module 43 of the user module 41 has the function of recognising voice, gestures, and behaviours so as to enable the operator 4 to control directly and/or indirectly the avatar 8. In particular, the command-recognition module 43 enables the operator 4 to carry out both a direct interaction imparting voice commands to the avatar 8 (which are processed and recognized via a voice-recognition software) and an indirect interaction via detection and interpretation of indirect signals of the operator 4, such as, for example, behaviours, attitudes, postures, positions of the body, expressions of the face, and tones of voice. In this way, it is possible to detect whether the operator 4 is in difficulty in performing the actions indicated and shown by the avatar 8, or to identify actions that can put the operator 4 in danger or damage the equipment present in the environment 5.

The command-recognition module 43 is connected to the behaviour engine 46 of the avatar module 44, to which it sends signals correlated to the vocal and behavioural commands detected for governing the behaviour of the avatar 8 accordingly. In this case, the behavioural information of the operator 4 is detected to evaluate, on the basis of the behaviours of the operator 4 or his facial expressions or the like, whether to make modifications to the actions of the procedure (for example, repeat some steps of the procedure itself).

The command-recognition module 43 can reside either in the local server 12 or in a memory of the portable computer device 10 and receives the vocal commands imparted by the operator 4 via the microphone 9b integrated in the HMD 9 and the behavioural commands through the movement sensors 7, the environmental video cameras 19, the wired gloves 29, and the microphone 9b.

The augmented-reality interface module 47 has the function of management of the augmented-reality elements, in particular the function of causing the avatar 8 to appear (via the appearance-of-avatar module 49) and of managing the behavioural procedures of the avatar 8 according to the environment 5 in which the operator 4 is located (for example, the procedures of training, assistance to maintenance, etc.). For this purpose, the 3D-recording module 48 detects the spatial arrangement and the position of the objects and of the equipment present in the working environment 5 on which the avatar 8 can interact and generates the three-dimensional digital map of the environment 5 and of the equipment arranged therein. Preferably, the appearance-of-avatar module 49 and the 3D-recording module 48 reside in a memory of the computer device 10 and/or of the local server 12 and/or of the movement-tracking unit 2, whilst the ensemble of the possible procedures that the avatar 8 can carry out and the digital map (generally of large dimensions) are stored in the local server 12 or in the movement-tracking unit 2.

As has been said, each of the procedures envisaged is specific for a type of assistance to be made available to the operator 4. For example, in the practical case of maintenance of a radar installed in a certain locality, the procedure will have available all the maintenance operations regarding that radar, taking into account the specificity of installation in that particular locality (relative spaces, encumbrance, etc.); in the case of a similar radar installed in another place and having a different physical location of the equipment, in the local server 12 there will be contained procedures similar to the ones described for the previous case, appropriately re-elaborated so as to take into account positioning of the avatar 8 in relation to the new surrounding locality. A plurality of maintenance or installation procedures or the like can be contained in the local server 12.

The avatar module 44, comprising the display engine 45 and the behaviour engine 46, resides preferably in the local server 12. The display engine 45 is responsible for graphic representation of the avatar 8; i.e., it defines the exterior appearance thereof and manages the movements thereof perceived by the operator 4 who wears the HMD 9. The display engine 45 is configured for generating graphically the avatar 8 by means of 3D-graphic techniques, for example based upon the ISO/IEC 19774 standard. In addition, this module defines and manages all the movements that the avatar 8 is allowed to make (moving its hands, turning its head, moving its lips, pointing with its finger, gesticulating, kneeling down, making steps, etc.). The display engine 45 is appropriately built in such a way as to be updated when necessary, for example, by replacing some functions (such as motion functions) and/or creating new ones, according to the need.

The behaviour engine 46 processes the data coming from the operator 4 (or detected by the computer device 10, by the behaviour engine 36, and/or by the assistant present in the technical-assistance centre 15 on the basis of the gestures, postures, movements of the operator 4) and checks that there is a correct interaction between the operator 4 and the avatar 8, guaranteeing, for example, that the maintenance procedure for which the avatar 8 is used is performed correctly by the operator 4.

The algorithm underlying the behaviour engine 46 is based upon mechanisms of continuous control during all the actions that the operator 4 performs under the guidance of the avatar 8, and upon the possibility of interrupting a current action and controlling the avatar 8 in such a way that it will intervene in real time on the current maintenance procedure, modifying it and personalizing it according to the actions of the operator 4. In addition, the behaviour engine 46 monitors the results and compares them with the pre-set targets so as to ensure that any procedure will be carried out entirely and in the correct way by the operator 4, envisaging also safety mechanisms necessary for safeguarding the operator 4 and all the apparatus and/or equipment present in the environment 5.

The behaviour engine 46 is of a software type and is responsible for processing and interpreting stimuli, gestural commands, and/or vocal commands coming from the operator 4, detected by means of the environmental sensors 3 co-operating with the movement sensors 7 (as regards the gestural commands) and by means of the microphone 9b (as regards the vocal commands). On the basis of said commands, the behaviour engine defines, manages, and controls the behaviour and the actions of the avatar 8 (for example, as regards the capacity of the avatar 8 to speak, answer questions, etc.) and interferes with the modes of display of the avatar 8 controlled by the display engine 45 (such as, for example, the capacity of the avatar to turn its head following the operator with its gaze, indicating an object or parts thereof with a finger, etc.). The behaviour engine 46 moreover defines and updates the vocabulary of the avatar 8 so that the avatar 8 will be able to dialogue, by means of a vocabulary of its own that can be freely updated, with the operator 4. In a way similar to the display engine 45, also the behaviour engine 46 is purposely designed in such a way that it can be updated whenever necessary, according to the need, in order to enhance, for example, the dialectic capacities of the avatar 8.

The display engine 45 and the behaviour engine 46 moreover communicate with one another so as to manage in a harmonious way gestures and words of the avatar 8. In fact, the behaviour engine 46 processes the stimuli detected through the environmental sensors 3 and/or movement sensors 7, and controls that the action for which the avatar 8 is used is performed in the correct way by the operator 4, directly, by managing the vocabulary of the avatar 8, and indirectly, through the functions of the display engine 45, the movements, and the display of the avatar 8.

Finally, the virtual-graphic module 50, which is optional, by communicating and interacting with the augmented-reality interface module 47, enriches and/or replaces the working environment 5 of the operator 4, reproducing and displaying the avatar 8 within a virtual site different from the environment 5 in which the operator 4 is effectively located. In this case, the HMD 9 is not of a see-through type, i.e., the operator does not see the real environment 5 that surrounds him.

The virtual-graphic module 50 is present and/or used exclusively in the case of augmented reality created in a virtual environment (and hence reconstructed in two or three dimensions and not real) and creates a virtual environment and graphic models of equipment or apparatus for which training and/or maintenance interventions are envisaged.

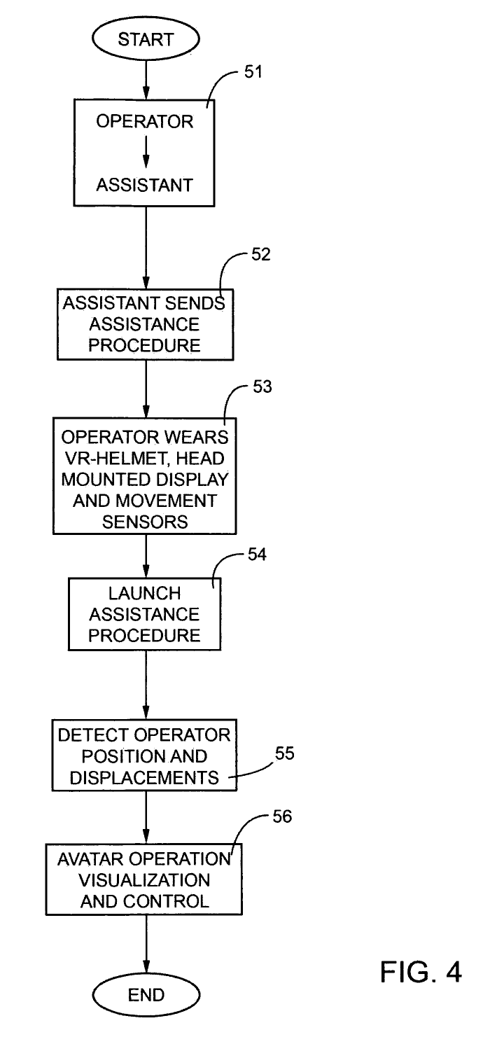

FIGS. 4-7 show respective methods of use of the present invention, alternative to one another.

FIG. 4 shows a method of use of the present invention whereby the procedure that the avatar 8 carries out is remotely provided, in particular by the technical-assistance centre 15, located at a distance from the environment 5 in which the operator 4 is working (see FIG. 1). In this case, the technical-assistance centre 15 is connected through the communications network 16 to the local server 12.

Initially (step 51), the operator 4, having become aware of an error event, for example, of an apparatus that he is managing, connects by means of the computer device 10 to the technical-assistance centre 15, exploiting the connection between the computer device 10 and the local server 12 and the connection via the communications network 16 of the local server 12 with the technical-assistance centre 15. The technical-assistance centre 15 is, as has been said, presided over by an assistant.

Then (step 52), the assistant, having understood the type of error event signalled, provides the operator 4 with the procedure envisaged for resolution of that error event (comprising, for example, the behavioural and vocal instructions that the avatar 8 may carry out). Given that said procedure is of a software type, it is supplied telematically, through the communications network 16.

Next (step 53), the operator 4 dons the HMD 9 and the movement sensors 7 (if envisaged by the type of movement-tracking apparatus 6 used) and (step 54) sets underway the actions of the procedure for resolution of the error event received by the technical-assistance centre 15.

In this case, steps 55, 56 comprise steps 22-35 of FIG. 2 described previously. The HMD 9 is, in this case, able to show the operator 4 the real surrounding environment 5 and is configured for displaying the image of the avatar 8 superimposed on the images of the environment 5. The avatar 8 has preferably a human shape and, moving freely in the environment 5, can dialogue with gestures and words with the operator 4. The avatar 8 is, as has been said, equipped with a vocabulary of its own, which is specific for the type of application and can be modified according to said application. Furthermore, the avatar 8 can answer with gestures and/or words to possible voice commands imparted by the operator 4.

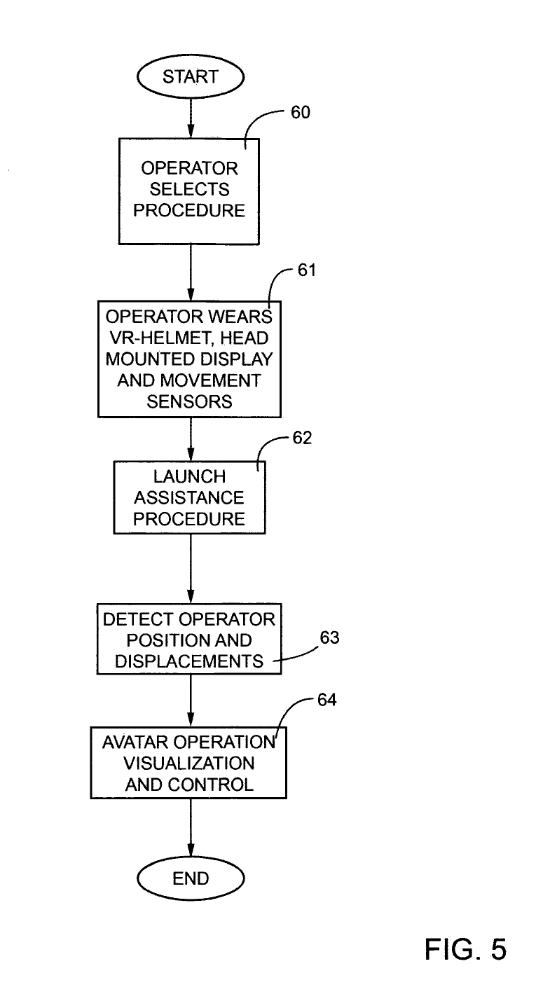

FIG. 5 shows a further method of use of the present invention according to which the procedure that the avatar 8 executes is chosen directly by the operator from a list of possible procedures, stored, for example, in the local server 12.

In this case (step 60), the operator 4, having become aware of an error event of, for example, an apparatus that he is managing, selects, from among a list of possible procedures, the procedure that he deems suitable to assist him in the resolution of the error event that has occurred. Said selection is preferably carried out by means of the computer device 10, which, by interfacing with the local server 12, retrieves from the local server 12 and stores in a memory of its own the instructions corresponding to said selected procedure.

The next steps 61, 62 are similar to steps 53, 54 of FIG. 4. The subsequent steps 63, 64 comprise the steps 22-35 of FIG. 2 described previously, and are not consequently further described here.

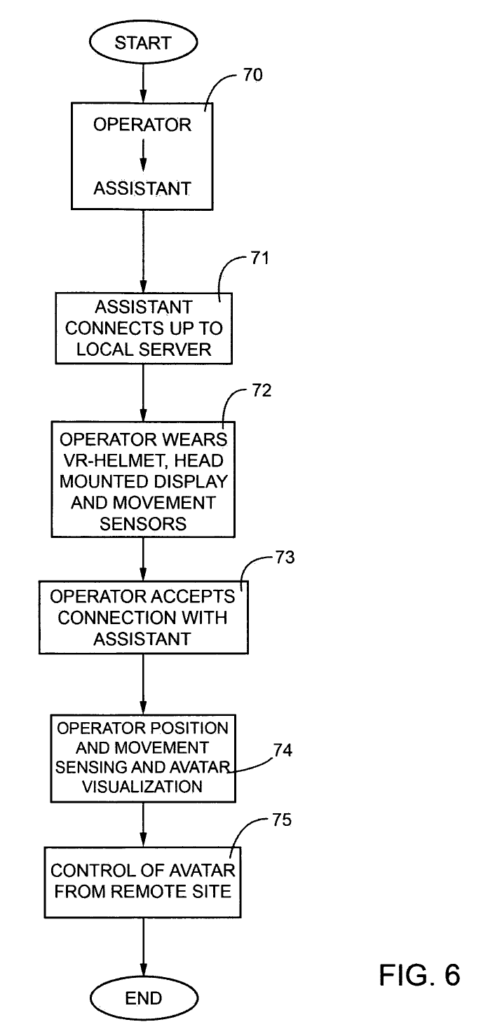

FIG. 6 shows another method of use of the present invention according to which the procedure that the avatar 8 performs is not predefined, but is managed in real time by the assistant present in the technical-assistance centre 15, who hence has direct control over the gestures and words of the avatar 8. In this case, the avatar 8 is governed in real time by means of appropriate text commands and/or by means of a joystick and/or a mouse and/or a keyboard, or any other tool that may be useful for interfacing the assistant with the avatar 8. In addition to the gestures, also the words uttered by the avatar 8 can be managed by the assistant or uttered directly by the assistant.

Initially (step 70), the operator 4 connects up with the assistant for requesting an intervention of assistance. In this case, the assistant decides to intervene by governing the avatar 8 in real time, and by managing himself the gestures of the avatar 8. Then (step 71), the assistant sends a request for communication with the local server 12, which in turn sends said request to the computer device 10 of the operator 4.

In step 72 the operator 4 dons the HMD 9 and the movement sensors 7 (if envisaged) and (step 73), accepts setting-up of the communication with the assistant, via the computer device 10. Next (step 74), the avatar 8 is displayed in a particular position of the environment 5, in a relative position with respect to the operator 4 (according to what has been already described with reference to FIG. 2). Steps 74, 75 are similar to the steps already described previously with reference to steps 22-35 of FIG. 2, with the sole difference that the assistant, having received and analysed the control information, directly governs remotely the movements of the avatar 8 and assists and/or instructs the operator 4, directly governing the avatar 8 in order to solve the error event that has occurred.

In this case, the assistant must be able observe the environment 5 and the equipment on which it is necessary to intervene. There must consequently be envisaged one or more video cameras designed to transmit high-resolution images to the technical-assistance centre 15 via the communications network 16. Said video cameras can advantageously be controlled by the assistant, who can thus carry out zooming or vary the frame according to the need.

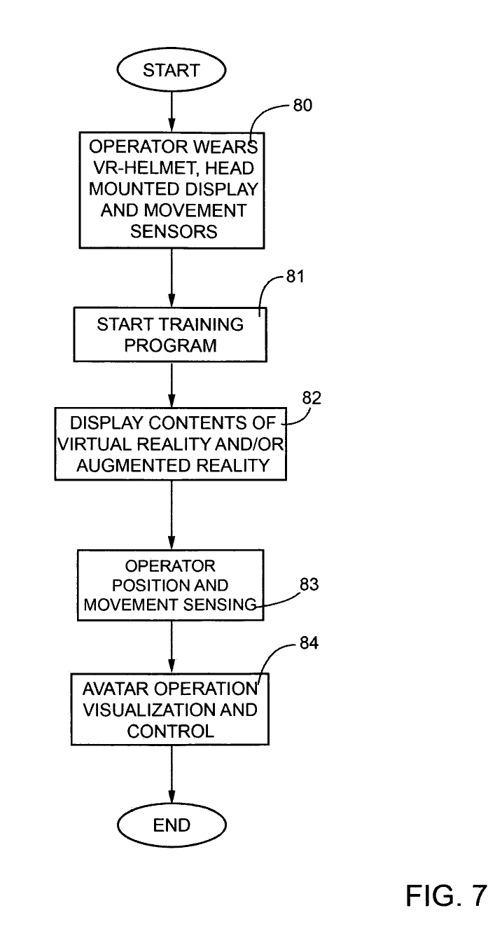

FIG. 7 shows a further method of use of the present invention that can be used in the case where the operator 4 does not require assistance for resolution of an error event, but wishes to carry out a training session, for example for acquiring new skills as regards maintenance of the equipment or apparatus which he manages.

In this case (step 80, the operator 4 dons the HMD 9 and the movement sensors 7 (if envisaged by the type of movement-tracking apparatus 6 used). Then (step 81), he sets underway, by means of the computer device 10, the training program that he wishes to use. The training program can reside indifferently on the computer device 10, on the local server 12, or can be received from the technical-assistance centre 15, either as set of software instruction or as real-time commands issued by the assistant. Since an effective training ought to be carried out in conditions where an error event has occurred, the training program used could comprise display of an environment 5, in which further augmented-reality elements are present, in addition to the avatar 8 (in particular, elements regarding the error event on which he wishes to train). Alternatively, the HMD 9 could display an environment 5 entirely as virtual reality, which does not reproduce the real environment 5 in which the operator is located for simulating the error events on which it is desired to carry out training.

Next (steps 82-84), irrespective of the type of mode chosen (based upon the real environment or upon a virtual environment) and in a way similar to what has been described previously with reference to steps 22-35 of FIG. 2, an avatar 8 is displayed, the behaviour and spatial location of which are at least in part defined according to the behaviours (or voice commands) and the spatial location of the operator 4 that is exploiting the training session.

From an examination of the characteristics of the system and of the method provided according to the present invention the advantages that it affords are evident.

In particular, the system and the method for collaborative assistance provided according to the present invention enable logistic support to the activities (for example, installation or maintenance) or training without the need for physical presence of a specialized technician in the intervention site. This is particularly useful in the case where it is necessary to intervene in areas that are difficult to reach, presided over by a very small number of operators, without a network for connection with a technical-assistance centre or provided with a connection with a poor or zero capacity of data transmission.

Finally, it is clear that modifications and variations may be made to the system and method for virtual collaborative assistance by means of avatar 8 described and illustrated herein, without thereby departing from the scope of the present invention, as defined in the annexed claims.

For example, the functions implemented by 2 and 12 can be implemented by a single fixed or portable computer, for example by just the local server 12 or by just the portable computer device 10, provided it is equipped with sufficient computational power.

For example, the collaborative supportive system 1 can be used for assisting visitors of shows, fairs, museums, exhibitions in general or archaeological sites. In this case, the avatar 8 has the function of virtual escort to visitors, guiding them around and describing to them the exhibits present.

In this case, the visitors wear each an HMD 9 and are equipped with one or more movement sensors 7. The route envisaged for the visitors, above all in the case of an exhibition in a closed place, comprises a plurality of environmental sensors 3, appropriately arranged along the entire route.

In the case of a visit to an archaeological site, the movement sensors 7 can be replaced by a GPS receiver.

The program that manages the gestures and speech of the avatar 8 is adapted to the specific case of the particular guided visit and can comprise information on the exhibition as a whole but also on certain exhibits in particular. The ability of the collaborative supportive system 1 to govern precisely the movements and gestures of the avatar 8 in fact enables the avatar 8 to describe the exhibits precisely. For example, in the case of a painting, the avatar 8 can describe it precisely, indicating with characteristic gestures details of the painting or of the style of painting or particular figurative elements represented.

In addition, the avatar 8 could be a two-dimensional or three-dimensional illustration different from a human figure, such as one or more pictograms or graphic, visual, or sound indications in general. It is evident that the avatar 8 can find application in other situations, different from the ones described previously.

A motorist, for example, when he is driving and without taking his eyes away from the road, could see in front the graphic instructions of the navigator and/or the indication of the speed, as well as warning of the presence of a motor vehicle in a blind spot of the rearview mirrors. Furthermore, the present invention can find application in the medical field, where intracorporeal vision obtained using echography and other imaging methods, could be superimposed on the actual vision of the patient himself so that a surgeon can have full consciousness of the direct and immediate effects of the surgical operation that he is carrying out on the patient: for example, a vascular surgeon could operate having alongside each blood vessel indications of the blood pressure and of the parameters of oxygenation of the blood.

Obviously, the possible applications of the present invention fall within any other field in which the addition of digital information of an audio/video type allied to control mechanisms, prove, or can prove, helpful.

1. An avatar-based collaborative supportive system (1), comprising:
movement-tracking sensor means (2, 3, 7), configured for tracking the movements of a user (4) and of one or more parts of his body;
display means (9); and
processing means (2, 10, 12), configured for co-operating with the movement-tracking sensor means (3, 7) and with the display means (9) to cause the display means (9) to display an avatar (8) capable of moving around in an environment (5) corresponding to the field of vision of the user, relating with the environment (5), and relating and interacting with the user (4) according to the assistance to be provided to the user.

2. The system according to claim 1, wherein the processing means (2, 10, 12) are configured for causing the display means (9) to display an avatar (8) having human features, movements, and gestures.

3. The system according to claim 1, wherein said movement-tracking sensor means (2, 3, 7) are configured for detecting expressions and/or postures and/or movements of the user and for co-operating with said processing means (2, 10, 12) so that said processing means (2, 10, 12) display the avatar (8), capable of relating and interacting with the user (4) on the basis of said expressions and/or postures and/or movements of the user (4) himself.

4. The system according to claim 1, wherein said movement-tracking sensor means (2, 3, 7) and said processing means (2, 10, 12) are configured for creating a digital map of the environment (5) and tracing the movements of the user (4) in the digital map, said configuration means being configured for displaying the avatar (8) capable of relating and interacting with the user (4) on the basis of said movements of the user (4) traced in the digital map.

5. The system according to claim 1, wherein the display means comprise a head-mounted display (9) that can be worn by the user (4).

6. The system according to claim 5, wherein the head-mounted display (9) is of the type suited for augmented-reality applications, and wherein the processing means (2, 10, 12) are configured for causing the head-mounted display (9) to display the avatar (8) superimposed on the environment (5) corresponding to the field of vision of the user.

7. The system according to claim 6, wherein the head-mounted display (9) is of the see-through type, and wherein the processing means (2, 10, 12) are configured for causing the head-mounted display (9) to display the avatar (8) superimposed on the environment (5) seen directly by the user through the head-mounted display (9).

8. The system according to claim 6, further comprising a camera (9a) that can be worn by the user for taking pictures of the environment, and wherein the processing means (2, 10, 12) are configured for causing the head-mounted display (9) to display the avatar (8) superimposed on the real picture of the area of the working environment (5) taken by the camera.

9. The system according to claim 5, wherein the processing means (2, 10, 12) are configured for causing the head-mounted display (9) to display the avatar (8) superimposed on a virtual image of the environment (5) corresponding to the field of vision of the user.

10. The system according to claim 1, further comprising a sound-reproduction device (13) that can be worn by the user, and wherein the processing means (2, 10, 12) are configured for causing the sound-reproduction device (13) to reproduce sound indications associated to gestural indications of the avatar (8).

11. The system according to claim 1, wherein the processing means (2, 10, 12) comprise:
a behaviour-management module (36), configured for determining the movements and the gestures of the avatar (8) in the environment (5); and
a display module (35), configured for causing the display means (9) to display the movements and the gestures of the avatar (8) in the environment determined by the behaviour-management module (36).

12. The system according to claim 11, wherein the processing means (2, 10, 12) comprise:
a command-recognition module (33), configured for recognizing gestural commands imparted by the user;
and wherein the behaviour-management module (36) is moreover configured for determining the movements and gestures of the avatar (8) in the environment (5) in response to the commands imparted by the user.

13. The system according to claim 12, further comprising a microphone (9b), and wherein the command-recognition module (33) is moreover configured for recognizing voice commands imparted by the user.

14. The collaborative supportive system according to claim 11 wherein the processing means (2, 10, 12) moreover comprise a movement-tracking module (2), configured for co-operating with the movement-tracking sensor means (3, 7) for determining the movements of the user (4) with respect to a three-dimensional-reference system, the orientation of the user in one or more of the three dimensions, the movements of parts of the body of the user (4).

15. The system according to claim 14, wherein the processing means (2, 10, 12) comprise a fixed computer (12), configured for implementing the movement-tracking module (2).

16. The system according to claim 11, wherein the processing means (2, 10, 12) moreover comprise a portable computer (10), configured for implementing the behaviour-management module (36) and the display module (35).

17. The system according to claim 15, wherein the fixed computer (12) is configured for storing different modes of behaviour and of display of the avatar (8) for one and the same type or for different types of assistance to be supplied to the user (4) and for indicating and/or supplying to the portable computer (10) the mode of behaviour and of display of the avatar (8) to be adopted for supplying the type of assistance requested by the user (4).

18. The system according to claim 16, wherein the portable computer (10) is configured for displaying a graphic interface, via which the user (4) can select the type of assistance that he wishes to receive from among a plurality of available types of assistance.

19. The system according to claim 15, wherein the fixed computer (12) is configured for communicating with a remote technical-assistance centre (15) through a telematic network (16) for receiving commands regarding management of the behaviour and of display of the avatar (8).

20. The system according to claim 1, wherein the processing means (2, 10, 12) are further configured to cause the avatar (8) to provide the user (4) with indications regarding maintenance of equipment, repair of faults, training, tourist indications.

21. A software product that can be loaded into processing means (2, 10, 12) of a collaborative supportive system based upon avatar (1) and designed to cause, when run, the processing means (2, 10, 12) to be configured as claimed in claim 1.
